(19) United States
(12) Patent Application Publication
(10) Pub. No.: US 2025/0335815 A1
(43) Pub. Date: Oct. 30, 2025

(54) FORECASTING MODEL DRIFT IN MACHINE LEARNING MODELS

(71) Applicant: Microsoft Technology Licensing, LLC, Redmond, WA (US)

(72) Inventors: Ankur MALLICK, Bellevue, WA (US); Sean Michael KULINSKI, Chicago, IL (US); Mayukh DAS, Kolkata (IN); Tsuwang HSIEH, Sammamish, WA (US); Chetan BANSAL, Seattle, WA (US)

(73) Assignee: Microsoft Technology Licensing, LLC, Redmond, WA (US)

(21) Appl. No.: 18/649,561

(22) Filed: Apr. 29, 2024

(51) Int. Cl. G06N 20/00

(52) U.S. Cl. CPC G06N 20/00

(57) ABSTRACT

Innovations in forecasting model drift in machine learning (“ML”) models are described. For example, a forecasting model is configured to forecast the nature and magnitude of model drift of an ML model, for a current query batch, based on historical features that quantify performance of the ML model for previous query batches. The results of forecasting model drift can be used to control selective retraining of the ML model. With selective retraining, the ML model can be updated in a timely manner based on observed behavior of the ML model for the previous query batches, before accuracy of the ML model drops due to model drift. In some cases, the ML model can be updated in a focused way based on observed behavior of the ML model for the previous query batches, to address a specific cause of inaccuracy.

### BACKGROUND

Machine learning (“ML”) has become a ubiquitous tool. ML models have been applied to various fields. In many cases, an ML model can achieve excellent performance on a narrow task for which the ML model has been trained. On the other hand, an ML model can be susceptible to “model drift” in which the ML model's performance at runtime falls below its expected performance. Model drift can be caused by changes in the type or distribution of inputs to the ML model, compared to the inputs that were expected when the ML model was trained. Alterations in inputs to the ML model can be targeted or malicious. In many cases, however, alterations in inputs to the ML model have benign or unintended causes, such as a shift in deployment environment that changes the prevalence of different inputs. Model drift can also be caused by changes in the correct mappings between inputs and outputs for the ML model, compared to the mappings that were correct when the ML model was trained. Changes in the mappings between inputs and outputs for the ML model can also be due to changes in the deployment environment, compared to the environment for which the ML model was trained.

In particular, model drift can be problematic in an ML streaming setting, in which a deployed ML model autonomously accepts a data stream and makes predictions without human action. In a streaming setting, input data shifts and other causes of model drift can be common. Due to the automated nature of the deployed ML model, model drift can easily be missed.

Some previous approaches to detecting and mitigating model drift rely on a fixed retraining schedule for an ML model (e.g., daily retraining or weekly retraining). A fixed retraining schedule can impose a high retraining cost, considering that retraining may be unnecessary for an ML model that is still effective. On the other hand, for an ML model that has become ineffective due to model drift, a fixed retraining schedule can lead to continued use of the ineffective ML model. Other previous approaches to detecting and mitigating model drift retrain an ML model after observing a drop in accuracy due to model drift. Such approaches are entirely backward-looking and, in some cases, can be slow to react to model drift. In other cases, such approaches can ineffectively cause retraining when temporary model drift is encountered. Still other previous approaches to detecting and mitigating model drift make strong assumptions about the nature of the model drift. In such approaches, an ML model can be updated based on the assumptions, without any mechanism for validating the assumptions on observed behavior of the ML model.

### SUMMARY

In summary, the detailed description presents innovations in forecasting model drift in machine learning (“ML”) models. For example, the innovations can provide a framework for forecasting the nature and magnitude of model drift of an ML model, for a current query batch, based on historical features that quantify performance of the ML model for previous query batches. The results of forecasting model drift can be used to control selective retraining of the ML model. With selective retraining, the ML model can be updated in a timely manner based on observed behavior of the ML model for previous query batches, before accuracy of the ML model drops due to model drift. In some cases, the ML model can be updated in a focused way based on observed behavior of the ML model for previous query batches, to address a specific cause of inaccuracy.

According to a first set of innovations described herein, a computer system forecasts model drift of an ML model. The computer system receives, at a forecasting model, historical features that quantify performance of the ML model for previous query batches. The historical features include a time series of historical values of a given error component (e.g., an error component that quantifies concept drift of the ML model between a training data set and a query batch; an error component that quantifies covariate shift due to difficult-to-classify samples in the training data set becoming more prevalent; or an error component that quantifies covariate shift due to infrequent samples in the training data set becoming more prevalent). The time series of historical values of the given error component includes values of the given error component for the previous query batches, respectively. With the forecasting model, the computer system predicts a value of the given error component for a current query batch using the time series of historical values of the given error component. For example, the computer system predicts the value of the given error component for the current query batch based on a trend value, seasonality value, auto-regressive value, and lagged regressor values. The computer system can similarly predict values of other error components for the current query batch. Based at least in part on the predicted value(s) of the error component(s) for the current query batch, the computer system determines a performance estimate of the ML model for the current query batch. Finally, based at least in part on the performance estimate, the computer system determines whether the ML model exhibits model drift. In this way, based on historical features that quantify performance of the ML model for previous query batches, the computer system can forecast the overall magnitude of model drift of the ML model for the current batch. Moreover, with reference to different error components, in some cases, the computer system can forecast the nature of model drift of the ML model for the current query batch.

According to a second set of innovations described herein, a computer system manages retraining of an ML model based on results of forecasting model drift of the ML model. The computer system uses a forecasting model to forecast model drift, for a current query batch, of the ML model based on historical features that quantify performance of the ML model for previous query batches. The historical features including a time series of historical values of a given error component. The time series of historical values of the given error component includes values of the given error component for the previous query batches, respectively. The computer system selectively retrains the ML model based on results of using the forecasting model to forecast model drift. For example, the computer system selects between complete retraining of the ML model, partial retraining (fine-tuning) of the ML model, and skipping retraining of the ML model. (With partial retraining, based on observed behavior of the ML model for the previous query batches, the ML model can be updated in a focused way to address a specific cause of inaccuracy.) If the ML model has been completely or partially retrained, the computer system resets the historical features that quantify performance of the ML model. Otherwise (retraining of the ML model has been skipped), the computer system can update the historical features that quantify performance of the ML model. For example, when labeled samples of the current query batch are available, the computer system determines a value of the given error component for the current query batch using the labeled samples of the current query batch and updates the time series of historical values of the given error component to include the value of the given error component for the current query batch. In this way, based on observed behavior of the ML model for the previous query batches, the ML model can be updated in a timely manner before accuracy of the ML model drops due to model drift.

According to a third set of innovations described herein, a forecasting model is trained to forecast model drift of an ML model. In each of multiple training iterations, a computer system performs operations for the training. The computer system receives, at the forecasting model, historical features that quantify performance of the ML model for previous query batches. The historical features include a time series of historical values of a given error component. With the forecasting model, the computer system predicts a value of the given error component for a current query batch using the time series of historical values of the given error component. The computer system can similarly predict values of other error components for the current query batch. Based at least in part on the predicted value(s) of the error component(s) for the current query batch, the computer system determines a performance estimate of the ML model for the current query batch. The computer system determines feedback based at least in part on differences between the performance estimate of the ML model for the current query batch and a performance metric of the ML model for the current query batch. (The performance metric of the ML model for the current query batch is a “ground truth” value.) The computer system adjusts the forecasting model based at least in part on the feedback.

The innovations described herein can be implemented as part of a method, as part of a computer system (physical or virtual) configured to perform the method, or as part of a tangible computer-readable media storing computer-executable instructions for causing a processor system, when programmed thereby, to perform the method. The various innovations can be used in combination or separately. The innovations described herein include the innovations covered by the claims. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures and illustrates a number of examples. Examples may also be capable of other and different applications, and some details may be modified in various respects all without departing from the spirit and scope of the disclosed innovations.

### BRIEF DESCRIPTION OF THE DRAWINGS

The following drawings illustrate some features of the disclosed innovations.

FIG. 1 is a flowchart illustrating an example technique for managing model drift of an ML model using results of forecasting model drift.

FIG. 2a is a flowchart illustrating an example technique for forecasting model drift of an ML model for a current query batch, and FIG. 2b is a flowchart showing operations performed, as part of the forecasting, to predict the value of a given error component using a time series of historical values of the given error component.

FIG. 3 is a flowchart illustrating an example technique for selectively retraining an ML model based on results of forecasting model drift.

FIG. 4 is a diagram illustrating different types of data drift.

FIG. 5 is a diagram illustrating aspects of forecasting model drift according to an example implementation.

FIG. 6 is a diagram illustrating relationships between a training data set, query batch, and shared support between the training data set and query batch.

FIG. 7 is a diagram illustrating an example computer system in which some described embodiments can be implemented.

### DETAILED DESCRIPTION

Innovations in forecasting model drift in machine learning (“ML”) models are described. For example, the innovations provide a framework for forecasting the nature and magnitude of model drift of an ML model, for a current query batch, based on historical features that quantify performance of the ML model for previous query batches. The results of forecasting model drift can be used to control selective retraining of the ML model. With selective retraining, the ML model can be updated in a timely manner based on observed behavior of the ML model for the previous query batches, before accuracy of the ML model drops due to model drift. In some cases, the ML model can be updated in a focused way to address a specific cause of inaccuracy of the ML model.

In general, in examples described herein, an ML model is a model which, after being “trained” on a training data set, can be used in “inference” operations to make predictions or classifications for new data (“query” data). The ML model can be implemented as a classification model, regression model (e.g., decision tree or random forest model), clustering model, deep learning model (e.g., autoencoder, multi-layer perceptron, convolutional neural network, or recurrent neural network), or another type of model. The ML model can be trained for any of various usage scenarios, such as a problem diagnosis for a cloud service or other service, providing recommendations, image recognition, speech recognition, image classification, object detection, facial recognition or other biometric recognition, emotion detection, question-answer responses (“chatbots”), natural language processing, automated language translation, query processing in search engines, automatic content selection, analysis of email and other electronic documents, relationship management, biomedical informatics, identification or screening of candidate biomolecules, generative adversarial networks, or other prediction or classification tasks.

Over time, performance of an ML model can degrade. Performance degradation of an ML model can be decomposed into several factors, which are termed error components. For example, a first type of error component quantifies “concept drift” of the ML model between a training data set and a given query batch. Labeled samples of the given query batch are available, which provide a “ground truth” for the mappings of inputs to outputs for the given query batch. In general, concept drift compares the input-output mappings that the ML model learned during training (from the training data set) to the ground-truth, input-output mappings for the given query batch. Other error components quantify types of “covariate shift” between samples of the training data set and samples of a given query batch. For example, a second type of error component quantifies covariate shift due to difficult-to-classify samples in the training data set becoming more prevalent in the given query batch. In general, this type of covariate shift can measure error due to a change in the prevalence of samples seen during training that were difficult to classify. As another example, a third type of error component quantifies covariate shift due to infrequent samples in the training data set that have become more prevalent in the given query batch.

### I. Example Approaches for Managing Model Drift.

This section describes various approaches to managing model drift of an ML model. The approaches use forecasting of model drift of the ML model for a current batch of data (“current query batch”). Before the forecasting, various operations have already been performed. In particular, the ML model has been trained using data in a training data set. After training, for runtime inference operations, the ML model has been used to map inputs in previous batches of data (“previous query batches”) to outputs. The performance of the ML model for the previous query batches has been evaluated, using labeled samples of the previous query batches, to generate historical features. The historical features quantify the performance of the ML model for the previous query batches. The historical features can be used to forecast model drift of the ML model for the current query batch. Based on the results of the forecasting, the ML model can be selectively retrained. Also, the historical features can be updated to account for samples of the current query batch, and the updated historical features can then be used in forecasting of model drift of the ML model for subsequent query batches.

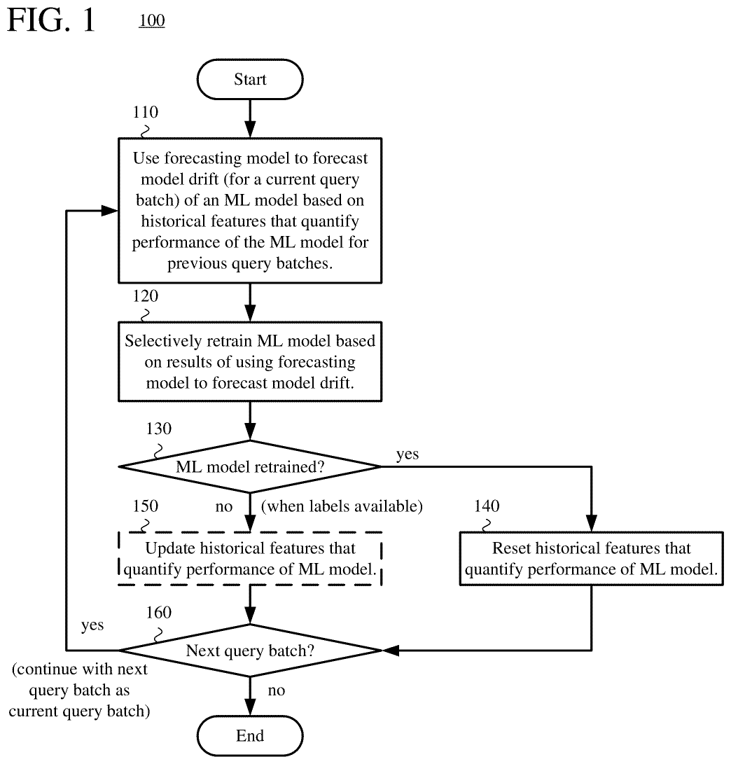

FIG. 1 shows an example technique (100) for managing model drift of an ML model using results of forecasting model drift. A computer system that implements an ML model and forecasting model can perform the technique (100).

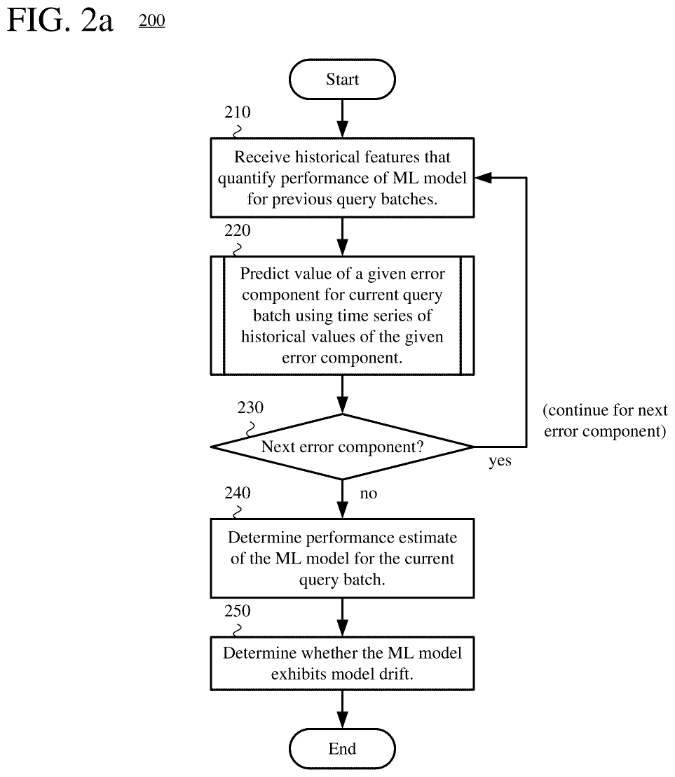

For a current query batch, the computer system uses (110) a forecasting model to forecast model drift of an ML model based on historical features that quantify performance of the ML model for previous query batches. The historical features include a time series of historical values of a given error component. The time series of historical values of the given error component includes values of the given error component for the previous query batches, respectively. For example, the computer system uses (110) the forecasting model to forecast model drift for the current query batch as explained with reference to FIG. 2a. Section V also explains examples of ways to forecast model drift using a forecasting model. Alternatively, the computer system uses the forecasting model to forecast model drift for the current query batch in some other way.

With reference to FIG. 1, based on results of using the forecasting model to forecast model drift, the computer system selectively retrains (120) the ML model. For example, the computer system selectively retrains (120) the ML model as explained in Section IV. More generally, the computer system can select between complete retraining of the ML model, partial retraining of the ML model, and skipping retraining of the ML model according to various criteria.

Thus, depending on the results of forecasting model drift, the computer system can completely retrain the ML model. In particular, the ML model can be completely retrained if the ML model exhibits significant concept drift in mappings of inputs to outputs. For example, the computer system determines that the ML model exhibits model drift due to concept drift of the ML model between a training data set and the current query batch. In response, the computer system performs complete retraining of the ML model using recent samples, which include labeled samples of the current query batch.

Or, depending on the results of forecasting model drift, the computer system can partially retrain (i.e., fine-tune) the ML model. In particular, the ML model can be partially retrained if an error component indicates covariate shift is significant for the current query batch. To address one type of covariate shift, the ML model can be adjusted to handle samples that were difficult to classify in training and hence are prone to misclassification. For example, the computer system determines that the ML model exhibits covariate shift due to difficult-to-classify samples in the training data set becoming more prevalent in the current query batch. In response, the computer system performs partial retraining of the ML model using mis-classified samples from the training data set. To address another type of covariate shift, the ML model can be adjusted to account for samples that have become more prevalent in the current query batch, compared to the training data set. For example, the computer system determines that the ML model exhibits covariate shift due to infrequent samples in the training data set becoming more prevalent in the current query batch. In response, the computer system performs partial retraining of the ML model using recent samples that were not in the training data set.

Or, depending on the results of forecasting model drift, the computer system can skip retraining of the ML model. In particular, retraining of the ML model can be skipped if a performance estimate of the ML model satisfies a performance threshold. The performance estimate of the ML model can be an overall accuracy value, which is calculated by combining a generalized error value (with multiple error components) for the current query batch and an accuracy value for the ML model from training.

The computer system can perform various operations after the selective retraining. For example, with reference to FIG. 1, the computer system checks (130) if the ML model has been completely or partially retrained. If so, the computer system resets (140) the historical features that quantify performance of the ML model. The historical features can be reset by initializing time series of values of error components. Constituent terms for different error components that depend on samples of a new training data set for the (retrained) ML model can also be recalculated.

If retraining of the ML model has been skipped, the computer system can update (150) the historical features that quantify performance of the ML model to account for the samples of the current query batch. For example, when labeled samples of the current query batch are available, the computer system determines a value of the given error component for the current query batch using the labeled samples of the current query batch. The computer system can similarly determine values of other error components for the current query batch using the labeled samples of the current query batch. Section V explains examples of ways to compute constituent terms for different error components and then use the constituent terms to determine values of the error components. The computer system then updates the time series of historical values of the respective error component(s) to include the value(s) of the error component(s) for the current query batch.

With reference to FIG. 1, the computer system checks (160) whether to continue with the next query batch. If so, the computer system continues with the next query batch as the current query batch. In this way, the computer system can manage the ML model by forecasting model drift of the ML model through successive query batches, updating the historical features that quantify performance of the ML model, and selectively retraining the ML model depending on the results of the forecasting. In many cases, based on observed behavior of the ML model, the ML model can be updated (retrained) in a timely manner before accuracy of the ML model drops due to model drift. Moreover, with partial retraining, the ML model can be updated in a focused way to address a specific cause of inaccuracy.

### II. Example Approaches to Forecasting Model Drift.

This section describes various approaches to forecasting model drift, for a current query batch, of an ML model based on historical features of previous query batches. The approaches can be used as part of an overall process of managing the ML model or can be used in another scenario.

FIG. 2a shows an example technique (200) for forecasting model drift of an ML model for a current query batch. A computer system that implements a forecasting model can perform the technique (200).

The computer system receives (210), at a forecasting model, historical features that quantify performance of an ML model for previous query batches. The historical features include a time series of historical values of a given error component. The time series of historical values of the given error component includes values of the given error component for the previous query batches, respectively. The historical features can also include times series of historical values of one or more other error components. For example, the given error component or another error component can be a first type of error component that quantifies concept drift of the ML model between a training data set and a given query batch. The given query batch can be one of the previous query batches or the current query batch. As another example, the given error component or another error component can be a second type of error component that quantifies covariate shift due to difficult-to-classify samples in the training data set becoming more prevalent in the given query batch. Or, as another example, the given error component or another error component can be a third type of error component that quantifies covariate shift due to infrequent samples in the training data set becoming more prevalent in the given query batch. Section V describes examples of error components in some example implementations.

With the forecasting model, the computer system predicts (220) a value of a given error component for a current query batch using the time series of historical values of the given error component. FIG. 2b shows example operations (221) that the computer system can perform to predict (220) the value of the given error component for the current query batch. Alternatively, the computer system can perform other operations to predict (220) the value of the given error component for the current query batch.

With reference to FIG. 2b, the computer system determines (222) a trend value for the current query batch. In general, the computer system determines the trend value for the current query batch by projecting along a trendline that has been fit to the training data set of the ML model. For example, the computer system determines a trend value T (t) for the current query batch at time t, as described in Section V. Alternatively, the trend value is determined in some other way.

The computer system also determines (223) a seasonality value for the current query batch. In general, the seasonality value for the current query batch quantifies seasonality effects according to a seasonality model that has been fit to the training data set of the ML model. For example, the computer system determines a seasonality value S (t) for the current query batch at time t, as described in Section V. Alternatively, the seasonality value is determined in some other way.

The computer system also determines (224) an auto-regressive value for the current query batch. In general, the computer system determines the auto-regressive value for the current query batch based on auto-regression of the time series of historical values of the given error component. The auto-regression of the time series of historical values of the given error component can use linear auto-regression, a neural network with a single hidden layer, a neural network with multiple hidden layers, or another mechanism. Thus, the auto-regressive value predicts the value of the given error component for the current query batch based on values of the given error component for previous query batches. For example, the computer system determines an auto-regressive value A(t) for the current query batch at time t, as described in Section V. Alternatively, the auto-regressive value is determined in some other way.

The computer system also determines (225) one or more lagged regressor values for the current query batch. In general, the computer system determines a lagged regressor value for the current query batch based on auto-regression of a time series of historical values of a different error component. (In other words, if the given error component is a first error component, the different error component is a second error component different than the first error component.) Thus, the lagged regressor value predicts the value of the given error component for the current query batch based on values of another, different error component (covariate) for the previous query batches. For example, the computer system determines a lagged regressor value L(t) for the current query batch at time t, as described in Section V. Alternatively, the lagged regressor value is determined in some other way.

FIG. 2b shows determination of a trend value, seasonality value, auto-regressive value, and lagged regressor value(s) in a particular order, but alternatively the values can be computed in a different order. Also, the computer system can determine other and/or additional values that contribute to the predicted value. For example, the computer system determines an events value for the current query batch, where the events value quantifies effects of events (e.g., holidays, other periodic events) for the current query batch.

The computer system determines (226) the predicted value of the given error component based on elementary values such as the trend value, seasonality value, auto-regressive value, and lagged regressor value(s). Thus, with reference to FIG. 2b, the predicted value of the given error component for the current query batch can incorporate the trend value, seasonality value, auto-regressive value, and lagged regressor value(s) for the current query batch, in addition to any other elementary value that has been determined (e.g., events value). For example, the computer system combines the elementary values by simply adding the elementary values.

With reference to FIG. 2a, the computer system checks (230) whether to continue for another error component. If so, the computer system continues by performing operations for the next error component as the given error component—receiving (210) historical features that quantify performance of the ML model for previous query batches and predicting (220) a value of the error component for the current query batch. Thus, the computer system can repeat the example operations (221) shown in FIG. 2b for multiple error components. The forecasting model can include multiple sub-models configured for the multiple error components, respectively. For example, in addition to predicting the value of a first error component (among the multiple error components), with different sub-models of the forecasting model, the computer system can predict a value of a second error component (among the multiple error components) for the current query batch using a time series of historical values of the second error component, and the computer system can also predict a value of a third error component (among the multiple error components) for the current query batch using a time series of historical values of the third error component.

Based at least in part on the predicted value of the given error component for the current query batch, the computer system determines (240) a performance estimate of the ML model for the current query batch. For example, based at least in part on the predicted value of the given error component (and any predicted values of other error components) for the current query batch, the computer system adjusts a measure of performance of the ML model as trained with a training data set.

Finally, based at least in part on the performance estimate of the ML model for the current query batch, the computer system determines (250) whether the ML model exhibits model drift. For example, the computer system compares the performance estimate to a performance threshold. The performance estimate can be an overall accuracy estimate based on the predicted values of multiple error components for the current query batch, and the performance threshold can be an overall accuracy threshold. If the overall accuracy estimate is lower than the overall accuracy threshold, the ML model may suffer from model drift due to any of various causes. Alternatively, the performance estimate can be based on the predicted value of a single error component for the current query batch, and the performance threshold be a component-specific threshold. Different performance estimates can be determined for different error components and compared to corresponding component-specific thresholds. In this way, specific causes of model drift may be identified.

Although FIG. 2a shows operations performed to forecast model drift of an ML model for a current query batch, the computer system can repeat the operations shown in FIG. 2a for successive query batches. The computer system can selectively retrain the ML model based on results of the forecasting, e.g., selecting between complete retraining of the ML model, partial retraining of the ML model, and skipping retraining of the ML model.

For use in forecasting model drift for subsequent query batches, the computer system can also perform operations to update the historical features that quantify performance of the ML model (e.g., when retraining is skipped). For example, when labels are available for samples of the current query batch, the computer system can determine a value of the given error component for the current query batch using labeled samples, including labeled samples of the current query batch. The computer system can then update the time series of historical values of the given error component to include the value of the given error component for the current query batch. The computer system can similarly determine values of other error components for the current query batch and update the time series of historical values of the other error components to include the values for the current query batch.

When determining the value of a given error component for the current query batch, the computer system performs operations to determine constituent terms of the given error component. In some cases, a constituent term is determined using labeled samples of a training data set or labeled samples of the current query batch. In other cases, a constituent term is determined using a classifier model that predicts whether a given sample is in a region of shared support between the training data set and current query batch. Section V describes examples of classifier models and operations to determine constituent terms of error components.

For example, when determining the value of a given error component (type of covariate shift) for the current query batch, the computer system determines a first loss metric that quantifies average loss for a training data set. The computer system uses a classifier model to identify a subset of samples of the training data set that are in a region of shared support with the current query batch. The computer system then determines a second loss metric that quantifies average loss for the subset of samples of the training data set in the region of shared support. As the value of the given error component (type of covariate shift), the computer system determines a difference between the second loss metric and the first loss metric.

Or, as another example, when determining the value of a given error component (other type of covariate shift) for the current query batch, the computer system uses a classifier model to identify a subset of samples of the current query batch that are in a region of shared support with a training data set. The computer system determines a first loss metric that quantifies average loss for the subset of samples of the current query batch in the region of shared support. The computer system also determines a second loss metric that quantifies average loss for the current query batch. As the value of the given error component (other type of covariate shift), the computer system determines a difference between the second loss metric and the first loss metric.

Or, as another example, when determining the value of a given error component (concept drift) for the current query batch, the computer system uses a classifier model to identify a subset of samples of a training data set that are in a region of shared support with the current query batch. The computer system determines a first loss metric that quantifies average loss for the subset of samples of the training data set in the region of shared support. The computer system also uses the classifier model to identify a subset of samples of the current query batch that are in a region of shared support with the training data set. The computer system determines a second loss metric that quantifies average loss for the subset of samples of the current query batch in the region of shared support. As the value of the given error component (concept drift), the computer system determines a difference between the second loss metric and the first loss metric.

### III. Example Approaches to Training a Forecasting Model.

This section describes various approaches to training a forecasting model to forecast model drift of an ML model. The training approaches can be applied to a forecasting model as described in Section II. The training approaches can be used for initial training of the forecasting model or for re-training of the forecasting model.

In general, the computer system trains the forecasting model to forecast model drift of an ML model using batches of training data in multiple training iterations. For example, in a given training iteration, the computer system receives, at the forecasting model, historical features that quantify performance of the ML model for previous training batches. (Initially, the previous training batches can be a subset of the training data that is used to populate the historical features without training on the previous training batches.) The historical features include a time series of historical values of a given error component. The time series of historical values of the given error component include values of the given error component for the previous training batches, respectively. With the forecasting model, the computer system predicts a value of the given error component for a current training batch using the time series of historical values of the given error component, for example, as described with reference to FIGS. 2a-2b or otherwise. Based at least in part on the predicted value of the given error component for the current training batch (as well as any predicted values of other error components for the current training batch), the computer system determines a performance estimate of the ML model for the current training batch.

Next, as part of the given training iteration, the computer system determines feedback based at least in part on differences between the performance estimate of the ML model for the current training batch and a performance metric of the ML model for the current training batch. The performance metric of the ML model for the current training batch is based on ground-truth data indicating the actual performance of the ML model for the current training batch. For example, the computer system determines a value of a reward function based on differences between the performance estimate of the ML model for the current training batch and the (actual) performance metric of the ML model for the current training batch.

The computer system then adjusts the forecasting model based at least in part on the feedback. For example, the computer system adjusts weight values and/or bias values in at least one layer of a convolutional neural network for the forecasting model, such as an AR-Net neural network configured to compute auto-regressive values for a given error component or an AR-Net neural network configured to compute lagged regressor values for another error component. Alternatively, the computer system adjusts the forecasting model in some other way.

The computer system can skip the adjustment of the forecasting model for some training batches. For example, the computer system aggregates the feedback for the current training batch with other feedback (from previous training batches). In this case, the adjustment of the forecasting model can use the aggregated feedback for the current training batch after skipping the adjustment for the previous training batches, or the adjustment of the forecasting model can be skipped for the current training batch.

In this way, the computer system can perform training for a current training batch. The computer system checks whether there are additional training batches in an epoch. (In general, an epoch is a pass through the samples in a training data set.) If there is a subsequent training batch in the epoch, the computer system continues with the next training batch as the current training batch. Thus, for each of one or more subsequent training batches treated as the current training batch, the computer system can repeat operations in another training iteration.

The process of training the forecasting model can continue for one or more epochs until the forecasting model reaches a convergence threshold. For example, the convergence threshold can be used to determine whether parameters of the forecasting model have stabilized (e.g., changes in parameters are below a threshold amount, which depends on implementation). Or, as another example, the convergence threshold can be used to determine whether differences between ground-truth performance metrics and output from the forecasting model are negligible (e.g., the value of the reward function has reached a threshold amount, which depends on implementation).

Thus, after completing processing for the training batches in the epoch, the computer system checks whether the forecasting model has reached a convergence threshold. If the forecasting model has reached the convergence threshold, the training process completes. If the forecasting model has not yet reached the convergence threshold, the computer system continues with a training batch as the current training batch (in another epoch) for another training iteration.

After training, the computer system stores the forecasting model for deployment.

### IV. Example Approaches to Selective Retraining.

This section describes example approaches to selective retraining of an ML model based on results of forecasting model drift of the ML model. The example approaches can be used as part of a processing of managing the ML model, as described in Section I, or used as part of another scenario.

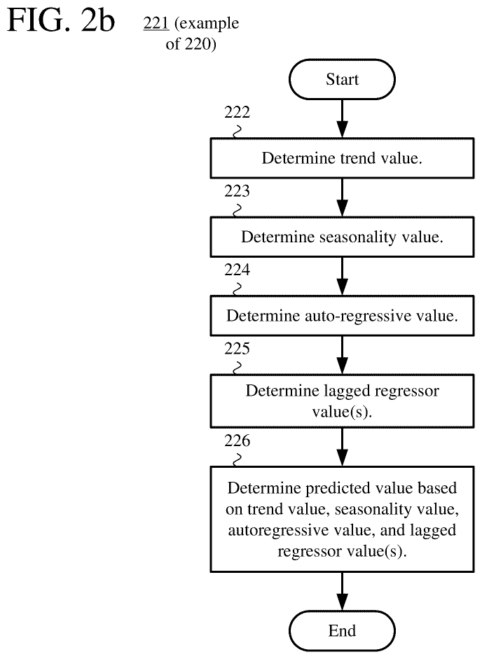

FIG. 3 shows an example technique (300) for selectively retraining an ML model based on results of forecasting model drift. A computer system that implements an ML model performs the technique (300).

The computer system evaluates (310) performance of the ML model based on results of forecasting model drift of the ML model for a current query batch. For example, the computer system compares an accuracy metric for the ML model for the current query batch against an accuracy threshold. Alternatively, the computer system compares multiple error components against thresholds for the respective error components.

The computer system checks (320) whether to retrain the ML model at all. If, according to the results of forecasting model drift of the ML model for the current query batch, the performance of the ML model continues to be satisfactory, the computer system skips retraining of the ML model. Otherwise (the performance of the ML model is no longer satisfactory for at least one reason), the computer system checks (330) whether model drift according to the results of forecasting is due to covariate shift.

If the model drift is not due to covariate shift (e.g., because the model drift is due to concept drift), the computer system retrains (340) the ML model on recent samples which have labels. This can involve completely retraining the ML model. Alternatively, the computer system can retrain (340) the ML model partially, using a set of samples to remediate the concept drift of the ML model.

Otherwise (the model drift is due to some type of covariate shift), the computer system checks (350) whether the model drift is due to a change in prevalence of difficult-to-classify samples in a training data set. (In examples in section V, the error component for “Shift P→S” measures this factor.) If so, the computer system fine-tunes (360) the ML model by training that includes misclassified samples from the training data set. Otherwise, the computer system fine-tunes (370) the ML model by training that includes recent samples that were not in the training data set.

### V. Example Implementations for Forecasting Model Drift in ML Models.

This section explains various aspects of innovations in forecasting model drift in ML models in some example implementations. The examples in this section use a specific nomenclature for query batches, error components, and other terms.

### A. Notation and Introduction.

Suppose a data stream D yields a batch of data

$${B}^{( t )} = \{ {( {x}_{i} , {y}_{i} )}_{i = 1}^{{N}^{( t )}} \}$$

at each time step t, where each sample is drawn from samples Q^{(t)} in a nonstationary deployment environment. An ML model h(x)=ŷ (also called a utility model) predicts a variable of interest y based on data inputs x. In the example implementations, the ML model is an offline model. (That is, the ML model is not being constantly retrained.) Also, the ML model was trained on a static set of historic batches P^{(train)}.

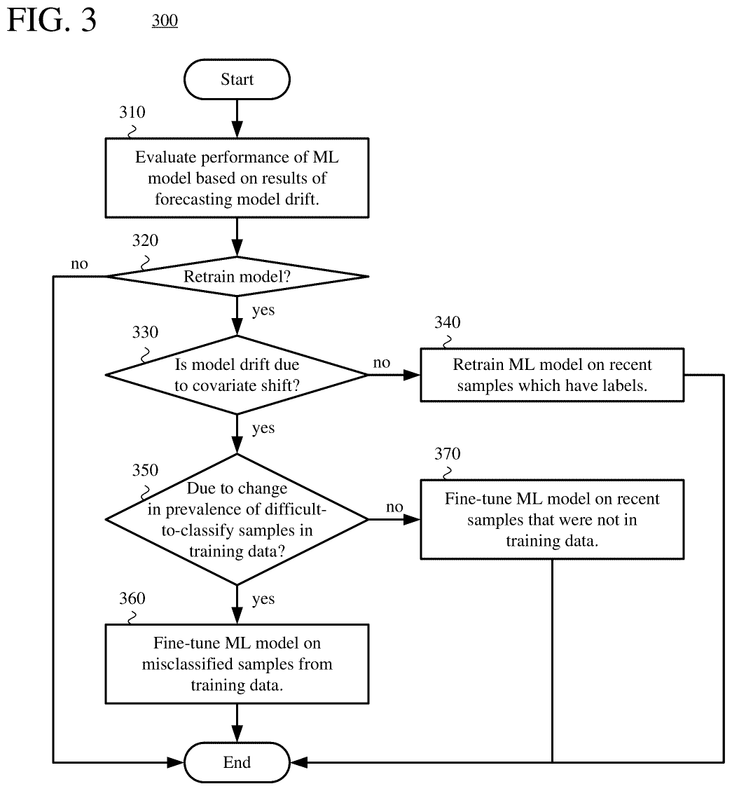

In a dynamic data-generating environment, over time there can be a distribution shift between the training distribution and the current data distribution. In other words, for a time t, P^{(train)}(x, y)≠Q^{(t)}(x, y). Often, the temporal shift essentially follows one of the drift patterns (401, 402, 403) shown in FIG. 4. In general, model drift is a cause for concern at time t if

$${α}_{h}^{( t )} < {α}_{min} ,$$

where

$${α}_{h}^{( t )}$$

is the overall accuracy of the ML model h for batch B^{(t)} at time t, and where αₘᵢₙ is an overall accuracy threshold that depends on implementation. The threshold is set to quantify a minimal acceptable risk. If

$${α}_{h}^{( t )} < {α}_{min} ,$$

the overall accuracy of the ML model has fallen below the overall accuracy threshold, which likely indicates an overall problem with the performance of the ML model. Even if αₕ^{(t)}>αₘᵢₙ, however, model drift of the ML model can be a problem. For example, if one of the error components (such as concept drift or a type of covariate shift) that affects overall accuracy is higher than a threshold for that error component (which depends on implementation), the ML model can suffer from model drift, even if other error components are low and overall accuracy is adequate. Thus, model drift can occur when an ML model encounters samples during inference that were infrequent during training or that were correctly classified during training only by random chance.

In FIG. 4, the “abrupt” drift pattern (401) exhibits sudden drift—a new concept occurs rapidly. The first “variable” drift pattern (402) shows recurring concepts—an old concept recurs. The second “variable” drift pattern (403) shows gradual drift—a new concept slowly replaces an old concept. The “steady” drift pattern (404) shows incremental drift—a new concept incrementally replaces an old concept.

Q^{(t)} represents the nonstationary environment in which the ML model h is operating in at time step t. (That is, Q^{(t)} represents samples of a current query batch at time t.) Q^{(t)}(x, y) is a joint distribution of the input vector x and target variable y. Depending on the stage or processing, the target variable y can be a classification label or regression value. The notation, (i:j) indicates aggregation over time points i to j (where i<j). For example, the vector of the previous k accuracy values of the ML model h is

$${α}_{h}^{( t - k : t )} ,$$

which is equivalent to

$${α}_{h}^{( t - k : t )} = [ {α}_{h}^{( t - k )} , {α}_{h}^{( t - k + 1 )} , ... , {α}_{h}^{( t )} ] .$$

To aggregate over the previous k nonstationary environments (for times earlier than t), Q^{(t-k:t)}(x, y) can be quantified as a mixture over the previous t−k distributions (that is, Q^{(t-k:t)}(x, y)∝Σ_{i∈{t, t-1, t-2, . . . , t-k}}Q⁽ⁱ⁾(x, y)).

Some previous approaches to drift mitigation are reactive. Such previous approaches wait for model drift to occur and only then react. In contrast, approaches in the example implementations are proactive. Historical environment and performance dynamics are used to forecast future performance of the ML model. This can enable reaction to potential shifts before the shifts become increasingly problematic.

In some example implementations, the forecasting of model drift is performed in an ML streaming environment. Typically, in an ML streaming environment, there are dependencies between batches over time. Data drift tends to be smooth (e.g., the “Steady” drift or “Variable” drift seen in FIG. 4). In general, detecting and mitigating smooth data drift might be insufficient, since an ML model's reaction to smooth data drift may not be smooth. In typical ML streaming, however, changes in the ML model's performance tend to be smooth given minor changes to input. With these characteristics of typical ML streaming environments, it is possible to extrapolate how data will drift in the future. For example, the mutual information I(B^{(t+1)}; {B^{(t:t-k)}}) is assumed to be high for reasonable values of k. Due to smoothness of the ML model, predictions can be reasonably made about how the ML model will perform on future data.

While the threshold αₘᵢₙ can be increased to cause earlier detection of model drift, doing so may cause reactions to short-term (transient) failures of the ML model. This could lead to many false positives, which would waste computing resources due to unnecessary retraining. For example, an extremely high setting of αₘᵢₙ would be equivalent to retraining the ML model after each batch. In contrast, approaches in the example implementations consider historical performance when forecasting model drift. This can help distinguish between transient failures (which should not trigger retraining) and persistent failures (which should trigger retraining).

### B. Example Error Decomposition and Error Components.

Historical concept drift and covariate shift statistics are efficiently incorporated in forecasting of model drift of an ML model. In general, historical concept drift and covariate shift statistics can be quantified as described in Namkoong et al., “Diagnosing Model Performance Under Distribution Shift,” arXiv preprint arXiv: 2303.02011 (2023).

Given a training distribution P(x, y) (for a training data set) and a test distribution Q(x, y) (for a query batch), the shared distribution Sₓ represents the region of shared support between marginal distributions Pₓ and Qₓ. The generalization error [symbol] _{Q}[ [symbol] (h(x),y)]− [symbol] ₚ[ [symbol] (h(x),y)] of an ML model h between the training data set and query batch can be decomposed into three semantically meaningful error components, which are labeled ϕ_{y|x} (or “Shift in y|x,” which is an example of concept drift), ϕ_{P→S} (or “Shift in P→S,” which is an example of a type of covariate shift), and ϕ_{S→Q} (or “Shift in S→Q,” which is an example of another type of covariate shift).

$${𝔼}_{Q} [ ℓ ( h ( x ) , y ) ] - {𝔼}_{p} [ ℓ ( h ( x ) , y ) ] = {𝔼}_{{S}_{x}} [ {R}_{Q} ( x ) - {R}_{P} ( x ) ] + ( {𝔼}_{{S}_{x}} [ {R}_{P} ( x ) ] - {𝔼}_{P} [ {R}_{P} ( x ) ] ) + ( {𝔼}_{Q} [ {R}_{Q} ( x ) ] - {𝔼}_{{S}_{x}} [ {R}_{Q} ( x ) ] ) .$$

R_{P}(x):= [symbol] _{P}[ [symbol] (h(X),y)|X=x] indicates the conditional risk of the ML model h on distribution P(y|x). The three error components of the generalization error can be interpreted as follows. The error component ϕy|x (shown above as [symbol] _{S}_{ₓ}[R_{Q}(x)−R_{P}(x)]) represents the “Shift in y|x” error component, which can be interpreted as error due to concept drift. This error component compares the input-output mappings h learned during training to the ground-truth mappings in the test domain. The error component ϕ_{P→S} (shown above as [symbol] _{S}_{ₓ}[R_{P}(x)]− [symbol] _{P}[R_{P}(x)]) represents the “Shift in P→S” error component, which can be viewed as error due to a change in the prevalence of samples seen during training that were difficult to classify. This error component compares the performance of the ML model under P_{y|x} between the settings where x is drawn from Pₓ and x is drawn from Sₓ. The error component ϕ_{S→Q} (shown above as [symbol] _{Q}[R_{Q}(x)]− [symbol] _{S}_{ₓ}[R_{Q}(x)]) represents the “Shift S→Q” error component, which can be viewed as error due to a change in the prevalence of samples from testing (with the query batch) that were infrequent during training. This error component measures the expected difference in loss under Q(y|x) between samples x˜Sₓ and x˜Qₓ.

In a streaming setting at time t, with access to labels, the generalization error

$${Δ}_{α}^{( t )}$$

can be decomposed as

$${Δ}_{α}^{( t )} = {ϕ}_{y \vert x}^{( t )} + {ϕ}_{P \to S}^{( t )} + {ϕ}_{S \to Q}^{( t )} .$$

A forecasting model can forecast sources of error for an ML model.

Collectively, the sources of error can be used to predict the performance of the ML model h at time t as

$$( {α}^{( t )} = {Δ}_{α}^{( t )} + {α}^{( train )} ) ,$$

where α^{(train)} is the performance of the ML model in training. With reference to specific error components, the forecasting model can also provide information about why the ML model h is expected to fail. For example,

$${ϕ}_{S \to Q}^{( t + 10 )}$$

can show an expected increase of out-of-distribution samples. In general, the forecasting model can take in kₕᵢₛₜ historical triplets of

$$\{ {( {ϕ}_{y \vert x}^{( t - i )} , {ϕ}_{P \to S}^{( t - i )} , {ϕ}_{S \to Q}^{( t - i )} )}_{i = 1}^{{k}_{hist}} \}$$

in order to predict a horizon of k_{future} future triples

$$\{ {( {ϕ}_{y \vert x}^{( t + j )} , {ϕ}_{P \to S}^{( t + j )} , {ϕ}_{S \to Q}^{( t + j )} )}_{j = 0}^{{k}_{future}} \} .$$

### C. Example Forecasting Models.

In some example implementations, a lightweight forecasting model f is used to forecast the performance of an ML model. Keeping the forecasting model lightweight reduces computational overhead. The forecasting tool can be used in an ML streaming pipeline in which human operators occasionally monitor the ML model. To facilitate interaction with the human operators, the forecasting model f is explainable. For example, the forecasting model f is a linear additive forecasting model generally based on a NeuralProphet model, as described in Triebe et al, “Neuralprophet: Explainable Forecasting at Scale,” arXiv preprint arXiv: 2111.15382 (2021).

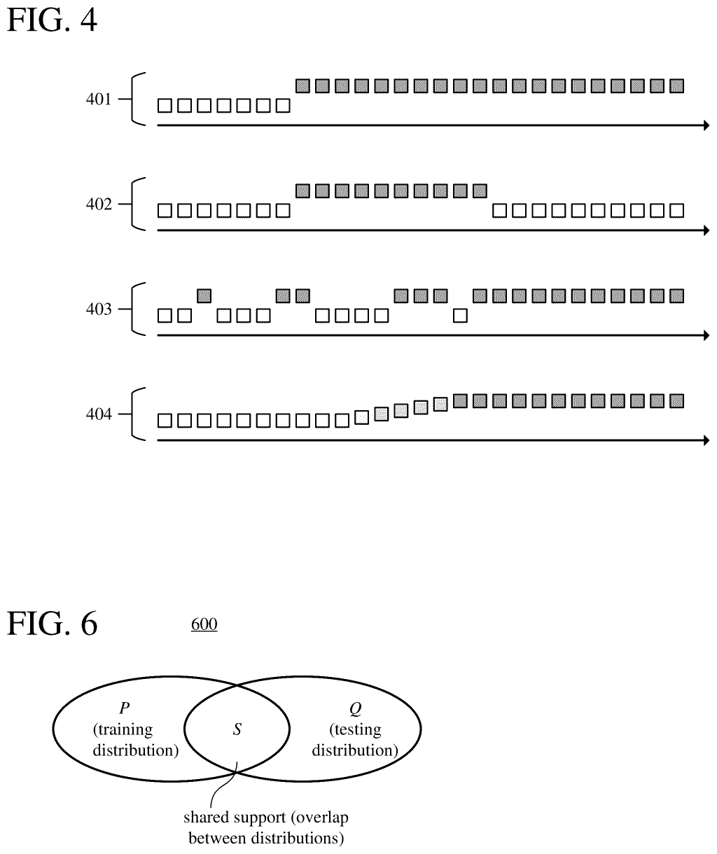

For example, the forecast of the forecasting model f is generated by summing a set of semantically meaningful scalar temporal components, including a value that quantifies trend effects at time t, a value that quantifies seasonality effects at time t, and values that quantify auto-regressive effects based on the p past observations. For a given error component, the values that quantify auto-regressive effects can include an auto-regressive value based on auto-regression on previous values of the given error component as well as lagged regressor values based on auto-regression on previous values of other error components (covariates). More specifically, the forecast of the forecasting model f incorporates auto-regressive components corresponding to historical concept drift and covariate shifts from previous batches. FIG. 5 illustrates features of the forecasting model f.

The set of kₕᵢₛₜ historical inputs to the forecasting model f is represented as

$$\{ {( {ϕ}_{y \vert x}^{( t - i )} , {ϕ}_{P \to S}^{( t - i )} , {ϕ}_{S \to Q}^{( t - i )} )}_{i = 1}^{{k}_{hist}} \} = {ϕ}^{( t - {k}_{hist} : t - 1 )} .$$

The set of k_{future} forecasts from the forecasting model f is represented as

$${ϕ}^{( t : t + {k}_{future} )} = \{ {( {ϕ}_{y \vert x}^{( t + j )} , {ϕ}_{P \to S}^{( t + j )} , {ϕ}_{S \to Q}^{( t + j )} )}_{j = 0}^{{k}_{future}} \} .$$

In some example implementations, the forecasting model f is a univariate forecasting model—it forecasts only one value for each time point for a given error component. To produce a multivariate forecast (for three different error components), three instances (sub-models) of the forecasting model f can be used in parallel, such that f(·)=[f_{P→S}(·), f_{S→Q}(·), f_{y|x}(·)].

When the forecasting model produces a single forecast (k_{future}=1), the forecast of

$$f ( {ϕ}^{t - {k}_{hist} : t - 1} ) = [ {ϕ}_{P \to S}^{( t )} , {ϕ}_{S \to Q}^{( t )} , {ϕ}_{y \vert x}^{( t )} ] .$$

For time t, the forecast for a given error forecast of component j is estimated as

$${ϕ}_{j}^{( t )} :$$

$${ϕ}_{j}^{( t )} = {\underbrace{T ( t )}}_{Trend} + {\underbrace{S ( t )}}_{Seasonality} + {\underbrace{A ( {ϕ}_{j}^{( t - {k}_{hist} : t - 1 )} )}}_{Auto - regressive on target} + {\underbrace{L ( {ϕ}_{j ′ \neq j}^{( t - {k}_{hist} : t - 1 )} )}}_{Auto - regressive on the covariates}$$

The value T(t) is a time-dependent trendline function that linearly extrapolates the value of ϕ^{(t)} based on a linear trendline learned during training. For example, a trend component is modeled using N_{c} piece-wise linear trendlines fit to the training data set during training. The value T(t) is a linear extrapolation along one of the trendlines (e.g., the most recent trendline.

The value S(t) is a seasonality value, based on a function that estimates the seasonality effects for ϕ^{(t)} using the sum of a set of Fourier terms. Each of the Fourier terms defines a “season” with periodicity p. Formally:

$$S ( t ) = {\sum }_{p ϵ P} {S}_{p} ( t ) = {\sum }_{j = 1}^{k} ( {a}_{j} cos ( \frac{2 π jt}{p} ) + {b}_{j} sin ( \frac{2 π jt}{p} ) ) .$$

The coefficients aⱼ and bⱼ of the respective Fourier terms can be determined during training.

The value A(ϕ^{(t-k}^{ₕᵢₛₜ}^{:t-1)}) is an auto-regressive value. It can be computed using a simple neural network such as AR-Net, as described in Triebe et al., “AR-Net: a Simple Auto-regressive Neural Network for Time-series,” arXiv preprint arXiv: 1911.12436 (2019). The neural network uses kₕᵢₛₜ previous target values to regress the next k_{future} target values in one forward pass. For example, for f_{P→S}, which has ϕ_{P→S} as its target value,

$${ϕ}_{P \to S}^{( t : t + {k}_{future} )} = AR - Net ( {ϕ}_{P \to S}^{( t - {k}_{hist} : t - 1 )} ) .$$

If AR-Net is a single layer neural network, then

$$AR - Net ( {ϕ}_{P \to S}^{( t - {k}_{hist} : t - 1 )} ) = W {ϕ}_{P \to S}^{( t - {k}_{hist} : t - 1 )} + b ,$$

where the weight values Wϵ [symbol] ^{k}^{ₕᵢₛₜ}^{×k}^{_{future}} and the bias values b∈ [symbol] _{future}^{k}. Alternatively, the AR-Net can be a multi-layer neural network. Typically, the number kₕᵢₛₜ of previous target values is double the number k_{future} of target values. Alternatively, the number kₕᵢₛₜ of previous target values can be much higher than the number k_{future} of target values, in combination with weight regularization to encourage the AR-Net to be sparse with respect to its inputs.

The value

$$L ( {ϕ}_{j ′ \neq j}^{( t - {k}_{hist} : t - 1 )} )$$

is a lagged regressors value.

$$L ( {ϕ}_{j ′ \neq j}^{( t - {k}_{hist} : t - 1 )} )$$

is used to correlate other observed non-target variables (that is, covariates) to the target value. Since the forecasting model f is three independent sub-models for different error components (f_{P→S}(·), f_{S→Q}(·), and f_{y|x}(·)), each given forecasting sub-model of the three forecasting sub-models can use the target values of the other two forecasting sub-models as the covariates for the given forecasting sub-model. For example, the covariates for f_{P→S} are {ϕ_{S→Q}, ϕ_{y|x}}. The function L is:

$$L ( {ϕ}_{j ′ \neq j}^{( t - {k}_{hist} : t - 1 )} ) = {\sum }_{j ′ \neq j} {L}_{j ′} ( {ϕ}^{( t - {k}_{hist} : t - 1 )} ) ,$$

where j is the index for the target variable (e.g., j=P→S). The function Lⱼ can be implemented as an AR-Net, as defined for the auto-regressive component. A different AR-Net can be trained for each of the covariates for a given error component.

With reference to FIG. 5, the forecasting model f accepts, as input, vectors (510) of historical features, such as raw representations of statistical divergences for covariate shift. The vectors (510) include historical concept drift statistics and historical covariate shift statistics, in addition to seasonality offsets. Functions (520) of the forecasting model f project from the vectors (510) of historical features to scalar values (530) for attributes. Depending on the attribute, a given one of the functions (520) can be implemented as a multi-layer perceptron, simple neural network, or other mechanism. The scalar values (530) represent contributions to model drift, such as a value CD(t) that quantifies concept drift at time t (which may incorporate an auto-regressive value as well as lagged regressor values for the concept drift error component), a value CS(t) that quantifies a type of covariate shift at time t (which may incorporate an auto-regressive value as well as lagged regressor values for the covariate shift error component), and a seasonality value Sea(t) at time t. The forecasting model combines the scalar values (530) to produce a sum (540) of the scalar values (530). Whereas the sum (540) provides an overall estimate of performance degradation, the scalar values (530) facilitate interpretation of causes of performance degradation.

### D. Computing Values of Error Components.

In some example implementations, the error components

$${ϕ}_{y \vert x}^{( t - i )} , {ϕ}_{P \to S}^{( t - i )} , {ϕ}_{S \to Q}^{( t - i )}$$

for historical samples (previous query batches) are computed based on constituent terms [symbol] _{S}_{ₓ}[R_{Q}(x)], [symbol] _{S}_{ₓ}[R_{P}(x)], [symbol] _{P}[R_{P}(x)], and [symbol] _{Q}[R_{Q}(x)], as shown above. Similarly, when labels are available for the samples of the current query batch, the error components

$${ϕ}_{y \vert x}^{( t )} , {ϕ}_{P \to S}^{( t )} , {ϕ}_{S \to Q}^{( t )}$$

can be computed in order to update the historical features.

The constituent terms [symbol] _{P}[R_{P}(x)] and [symbol] _{Q}[R_{Q}(x)] are estimated via empirical average losses for the data sets P and Q, respectively. P is the data set used to train the ML model h, and Q is the data set for a query batch (e.g., [symbol] ^{(t-1)}). The data used to estimate the terms [symbol] _{P}[R_{P}(x)] and [symbol] _{Q}[R_{Q}(x)] (and the terms [symbol] _{S}_{ₓ}[R_{Q}(x)] and [symbol] _{S}_{ₓ}[R_{P}(x)]) is labeled.

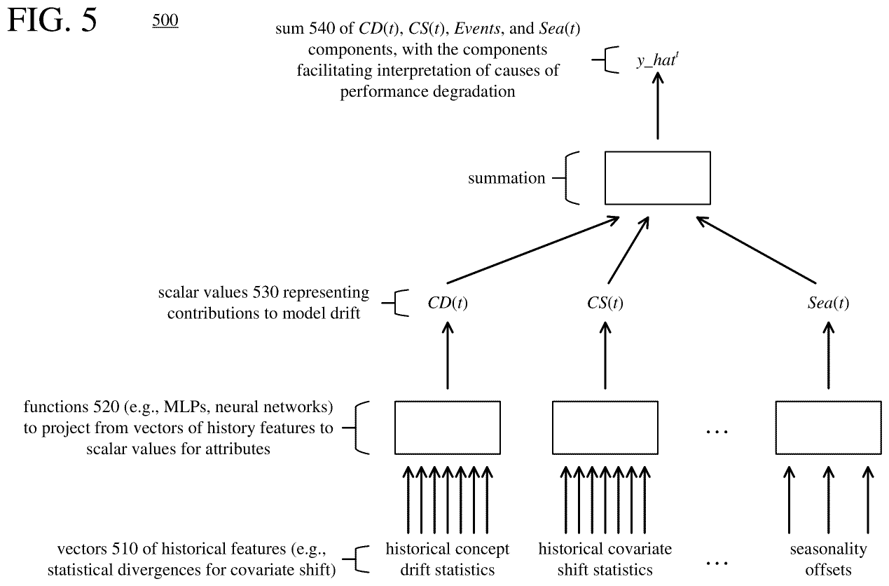

The terms [symbol] _{S}_{ₓ}[R_{Q}(x)] and [symbol] _{S}_{ₓ}[R_{P}(x)] are estimated for samples of the support region S, which is shared between P and Q as shown in FIG. 6. In particular, [symbol] _{S}_{ₓ}[R_{Q}(x)] and [symbol] _{S}_{ₓ}[R_{P}(x)] are estimated using only samples drawn from P and Q. In some example implementations, a weighting is applied to a given sample to assess how much the sample “looks like” it could come from Sₓ, following the procedure of Algorithm 1 in Namkoong et al., “Diagnosing Model Performance Under Distribution Shift,” arXiv preprint arXiv: 2303.02011 (2023). For this classification process, a simple domain classifier î is trained to predict whether a given sample is from the training data set P or query batch Q. The classifier yields \hat{π}(x_{μ})≈Prob(μ=Q|X=x_{μ}). Since there is typically an uneven mixture of samples from Pₓ and Qₓ (e.g., more samples in the training data set than in the query batch), an adjusted base rate

$$\hat{β} = \frac{{N}_{Q}}{{N}_{P} + {N}_{Q}}$$

can be used to standardize results. The importance weights can be defined as:

$${w}_{P} ( \hat{π} ( x ) , \hat{β} ) = \frac{\hat{π} ( x )}{( 1 - \hat{β} ) \hat{π} ( x ) + \hat{β} ( 1 - \hat{π} ( x ) )}$$

$${w}_{Q} ( \hat{π} ( x ) , \hat{β} ) = 1 - {w}_{P} ( \hat{π} ( x ) , \hat{β} )$$

With the weights, the terms [symbol] _{S}_{ₓ}[R_{Q}(x)] and [symbol] _{S}_{ₓ}[R_{P}(x)] can be estimated as:

$${𝔼}_{{S}_{x}} [ {R}_{P} ( x ) ] \approx \frac{{\sum }_{i = 1}^{{N}_{P}} ℓ ( h ( {x}_{i} ) , {y}_{i} ) {w}_{P} ( \hat{π} ( {x}_{i} ) , \hat{β} )}{{\sum }_{i = 1}^{{N}_{P}} {w}_{P} ( \hat{π} ( {x}_{i} ) , \hat{β} )}$$

$${𝔼}_{{S}_{x}} [ {R}_{Q} ( x ) ] \approx \frac{{\sum }_{i = 1}^{{N}_{Q}} ℓ ( h ( {x}_{i} ) , {y}_{i} ) {w}_{Q} ( \hat{π} ( {x}_{i} ) , \hat{β} )}{{\sum }_{i = 1}^{{N}_{Q}} {w}_{Q} ( \hat{π} ( {x}_{i} ) , \hat{β} )}$$

With the constituent terms [symbol] _{S}_{ₓ}[R_{Q}(x)], [symbol] _{S}_{ₓ}[R_{P}(x)], [symbol] _{P}[R_{P}(x)], and [symbol] _{Q}[R_{Q}(x)] for a time t−i, the error components

$${ϕ}_{y \vert x}^{( t - i )} , {ϕ}_{P \to S}^{( t - i )} , {ϕ}_{S \to Q}^{( t - i )}$$

for historical samples in previous query batches can be computed. Similarly, when labels are available for the samples of the current query batch, the error components

$${ϕ}_{y \vert x}^{( t )} , {ϕ}_{P \to S}^{( t )} , {ϕ}_{S \to Q}^{( t )}$$

can be computed in order to update the historical features.

The classifier \hat{π} can be implemented using any of various ML classifier approaches (e.g., random forest, neural network, logistic regression, support vector machine), which may be trained using supervised learning, reinforcement learning, or another approach. Some additional considerations for training a classifier \hat{π} in the specific context of model drift diagnosis are described in Appendices D and E of Namkoong et al., “Diagnosing Model Performance Under Distribution Shift,” arXiv preprint arXiv: 2303.02011 (2023).

### E. Example Usage Scenario.

In one usage scenario, the performance of an ML model h is forecast using a specific data set—the NYC Taxicab data set. This data set contains records of taxi trips with fields capturing pick-up and drop-off dates/times, pick-up and drop-off locations, trip distances, itemized fares, rate types, payment types, and driver-reported passenger counts. The ML model h is a random forest classifier that accepts, as input, ride details (e.g., pick-up and drop-off locations, trip distance, payment types, base fare cost, etc.) and predicts whether the rider gave a good tip (where a good tip is at least 20% of the base fare cost). The ML model h was trained on data from four months of cab rides (September 2017-December 2017) and then “deployed” (tested) on the entire next year of cab rides (January 2018-December 2018). To simulate an ML streaming environment, the time step t corresponds to one day. All rides from the same day are batched into one batch.

The forecasting model f is configured to have a forecast history of one month and a forecast horizon of 1 week (that is, kₕᵢₛₜ=31 and k_{future}=7). The forecasting model is trained on the first 8 months of the deployment performance of the ML model h (that is, the forecasting model f is trained on ϕ^{(1, 2, . . . , 243)}). The forecasting model f is then tested on the remaining 4 months of the year. For this scenario, the reconstructed generalization error (calculated via \hat{ϕ}_{P→S}+\hat{ϕ}_{S→Q}+\hat{ϕ}_{y|x}) nearly matches the true generalization error, both in the training period and the extrapolation (inference) period. Over time, an increasing proportion of the error is due to ϕ_{S→Q}, which suggests that the testing distribution diverges from the training distribution over time.

In conclusion, a novel and principled framework for forecasting the nature and magnitude of data drift is described. In example scenarios, the approach closely follows ground truth accuracy/drift measurements. The forecasting model can be used to control low-cost, adaptive retraining of an ML model h. In this way, future data drift can be preempted. Model drift can be mitigated based on observed behavior of the ML model h and trends in the drift.

### VI. Example Computer Systems.

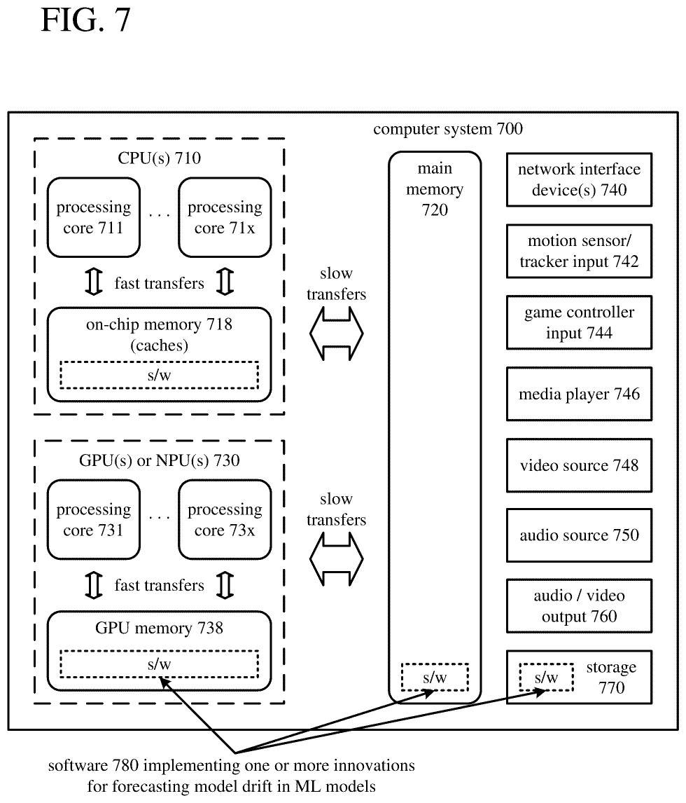

FIG. 7 illustrates a generalized example of a suitable computer system (700) in which several of the described innovations may be implemented. The innovations described herein relate to use of forecasting of model drift in ML models. The computer system (700) is not intended to suggest any limitation as to scope of use or functionality, as the innovations may be implemented in diverse computer systems, including special-purpose computer systems.

With reference to FIG. 7, the computer system (700) includes one or more processing cores (711 . . . 71x) and local memory (718) of a central processing unit (“CPU”) (710) or multiple CPUs. The processing core(s) (711 . . . 71x) are, for example, processing cores on a single chip, and execute computer-executable instructions. The number of processing core(s) (711 . . . 71x) depends on implementation and can be, for example, 4 or 8. The local memory (718) may be volatile memory (e.g., registers, cache, random access memory (“RAM”)), non-volatile memory (e.g., read-only memory (“ROM”), electrically erasable programmable ROM (“EEPROM”), flash memory), or some combination of the two, accessible by the respective processing core(s) (711 . . . 71x). Alternatively, the processing cores (711 . . . 71x) can be part of a system-on-a-chip (“SoC”), application-specific integrated circuit (“ASIC”), or other integrated circuit.

The local memory (718) can store software (780) implementing aspects of the innovations for forecasting of model drift in ML models, for operations performed by the respective processing core(s) (711 . . . 71x), in the form of computer-executable instructions. In FIG. 7, the local memory (718) is on-chip memory such as one or more caches, for which access operations, transfer operations, etc. with the processing core(s) (711 . . . 71x) are fast.

The computer system (700) also includes processing cores (731 . . . 73x) and local memory (738) of a graphics processing unit (“GPU”) or neural processing unit (“NPU”) (730) or multiple GPUs or NPUs. The number of processing cores (731 . . . 73x) of the GPU or NPU depends on implementation. For a GPU, the processing cores (731 . . . 73x) are, for example, part of single-instruction, multiple data (“SIMD”) units of the GPU. The SIMD width n, which depends on implementation, indicates the number of elements (sometimes called lanes) of a SIMD unit. For an NPU, the processing cores (731 . . . 73x) include, for example, specialized ML hardware blocks for operations such as matrix multiplication and convolution. The memory (738) may be volatile memory (e.g., registers, cache, RAM), non-volatile memory (e.g., ROM, EEPROM, flash memory), or some combination of the two, accessible by the respective processing cores (731 . . . 73x). The memory (738) can store software (780) implementing aspects of the innovations for forecasting of model drift in ML models, for operations performed by the respective processing cores (731 . . . 73x), in the form of computer-executable instructions such as shader code (for a GPU) or specialized code for ML hardware blocks (for an NPU).

The computer system (700) includes main memory (720), which may be volatile memory (e.g., RAM), non-volatile memory (e.g., ROM, EEPROM, flash memory), or some combination of the two, accessible by the processing core(s) (711 . . . 71x, 731 . . . 73x). The main memory (720) stores software (780) implementing aspects of the innovations for forecasting of model drift in ML models, in the form of computer-executable instructions. In FIG. 7, the main memory (720) is off-chip memory, for which access operations, transfer operations, etc. with the processing cores (711 . . . 71x, 730 . . . 73x) are slower.

More generally, the term “processor” refers generically to any device that can process computer-executable instructions and may include a microprocessor, microcontroller, programmable logic device, digital signal processor, and/or other computational device. A processor may be a processing core of a CPU, other general-purpose unit, GPU, or NPU. A processor may also be a specific-purpose processor implemented using, for example, an ASIC or a field-programmable gate array (“FPGA”). A “processor system” is a set of one or more processors, which can be located together or distributed across a network.

The term “control logic” refers to a controller or, more generally, one or more processors, operable to process computer-executable instructions, determine outcomes, and generate outputs. Depending on implementation, control logic can be implemented by software executable on a CPU, by software controlling special-purpose hardware (e.g., a GPU, other graphics hardware, or NPU), or by special-purpose hardware (e.g., in an ASIC).

The computer system (700) includes one or more network interface devices (740). The network interface device(s) (740) enable communication over a network to another computing entity (e.g., server, other computer system). The network interface device(s) (740) can support wired connections and/or wireless connections, for a wide-area network, local-area network, personal-area network, or other network. For example, the network interface device(s) can include one or more Wi-Fi® transceivers, an Ethernet® port, a cellular transceiver and/or another type of network interface device, along with associated drivers, software, etc. The network interface device(s) (740) convey information such as computer-executable instructions, audio or video input or output, or other data in a modulated data signal over network connection(s). A modulated data signal is a signal that has one or more of its characteristics set or changed in such a manner as to encode information in the signal. By way of example, the network connections can use an electrical, optical, RF, or other carrier.

The computer system (700) optionally includes a motion sensor/tracker input (742) for a motion sensor/tracker, which can track the movements of a user and objects around the user. For example, the motion sensor/tracker allows a user (e.g., player of a game) to interact with the computer system (700) through a natural user interface using gestures and spoken commands. The motion sensor/tracker can incorporate gesture recognition, facial recognition and/or voice recognition.

The computer system (700) optionally includes a game controller input (744), which accepts control signals from one or more game controllers, over a wired connection or wireless connection. The control signals can indicate user inputs from one or more directional pads, buttons, triggers and/or one or more joysticks of a game controller. The control signals can also indicate user inputs from a touchpad or touchscreen, gyroscope, accelerometer, angular rate sensor, magnetometer and/or other control or meter of a game controller.

The computer system (700) optionally includes a media player (746) and video source (748). The media player (746) can play DVDs, Blu-ray™ discs, other disc media and/or other formats of media. The video source (748) can be a camera input that accepts video input in analog or digital form from a video camera, which captures natural video. Alternatively, the video source (748) can be a screen capture module (e.g., a driver of an operating system, or software that interfaces with an operating system) that provides screen capture content as input. Or, as another alternative, the video source (748) can be a graphics engine that provides texture data for graphics in a computer-represented environment. Or, as another alterative, the video source (748) can be a video card, TV tuner card, or other video input that accepts input video in analog or digital form (e.g., from a cable input, High-Definition Multimedia Interface (“HDMI”) input or other input).

An optional audio source (750) accepts audio input in analog or digital form from a microphone, which captures audio, or other audio input.

The computer system (700) optionally includes a video output (760), which provides video output to a display device. The video output (760) can be an HDMI output or other type of output. An optional audio output (760) provides audio output to one or more speakers.

The storage (770) may be removable or non-removable, and includes magnetic media (such as magnetic disks, magnetic tapes or cassettes), optical disk media and/or any other media which can be used to store information, and which can be accessed within the computer system (700). The storage (770) stores instructions for the software (780) implementing aspects of the innovations for forecasting of model drift in ML models.

The computer system (700) may have additional features. For example, the computer system (700) includes one or more other input devices and/or one or more other output devices. The other input device(s) may be a touch input device such as a keyboard, mouse, pen, or trackball, a scanning device, or another device that provides input to the computer system (700). The other output device(s) may be a printer, CD-writer, or another device that provides output from the computer system (700).

An interconnection mechanism (not shown) such as a bus, controller, or network interconnects the components of the computer system (700). Typically, operating system software (not shown) provides an operating environment for other software executing in the computer system (700), and coordinates activities of the components of the computer system (700).

The computer system (700) of FIG. 7 is a physical computer system. A virtual machine can include components organized as shown in FIG. 7.

The term “application” or “program” refers to software such as any user-mode instructions to provide functionality. The software of the application (or program) can further include instructions for an operating system and/or device drivers. The software can be stored in associated memory. The software may be, for example, firmware. While it is contemplated that an appropriately programmed general-purpose computer or computing device may be used to execute such software, it is also contemplated that hard-wired circuitry or custom hardware (e.g., an ASIC) may be used in place of, or in combination with, software instructions. Thus, examples described herein are not limited to any specific combination of hardware and software.

The term “computer-readable medium” refers to any medium that participates in providing data (e.g., instructions) that may be read by a processor and accessed within a computing environment. A computer-readable medium may take many forms, including non-volatile media and volatile media. Non-volatile media include, for example, optical or magnetic disks and other persistent memory. Volatile media include dynamic random-access memory (“DRAM”). Common forms of computer-readable media include, for example, a solid-state drive, a flash drive, a hard disk, any other magnetic medium, a CD-ROM, DVD, any other optical medium, RAM, programmable read-only memory (“PROM”), erasable programmable read-only memory (“EPROM”), a USB memory stick, any other memory chip or cartridge, or any other medium from which a computer can read. The term “non-transitory computer-readable media” specifically excludes transitory propagating signals, carrier waves, and wave forms or other intangible or transitory media that may nevertheless be readable by a computer. The term “carrier wave” may refer to an electromagnetic wave modulated in amplitude or frequency to convey a signal.

The innovations can be described in the general context of computer-executable instructions being executed in a computer system on a target real or virtual processor. The computer-executable instructions can include instructions executable on processing cores of a general-purpose processor to provide functionality described herein, instructions executable to control a GPU, NPU, or special-purpose hardware to provide functionality described herein, instructions executable on processing cores of a GPU or NPU to provide functionality described herein, and/or instructions executable on processing cores of a special-purpose processor to provide functionality described herein. In some implementations, computer-executable instructions can be organized in program modules. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computer system.

The terms “system” and “device” are used interchangeably herein. Unless the context clearly indicates otherwise, neither term implies any limitation on a type of computer system or device. In general, a computer system or device can be local or distributed, and a computer system can include any combination of special-purpose hardware and/or hardware with software implementing the functionality described herein.

Numerous examples are described in this disclosure and are presented for illustrative purposes only. The described examples are not, and are not intended to be, limiting in any sense. The presently disclosed innovations are widely applicable to numerous contexts, as is readily apparent from the disclosure. One of ordinary skill in the art will recognize that the disclosed innovations may be practiced with various modifications and alterations, such as structural, logical, software, and electrical modifications. Although particular features of the disclosed innovations may be described with reference to one or more particular examples, it should be understood that such features are not limited to usage in the one or more particular examples with reference to which they are described, unless expressly specified otherwise. The present disclosure is neither a literal description of all examples nor a listing of features of the invention that must be present in all examples.

When an ordinal number (such as “first,” “second,” “third” and so on) is used as an adjective before a term, that ordinal number is used (unless expressly specified otherwise) merely to indicate a particular feature, such as to distinguish that particular feature from another feature that is described by the same term or by a similar term. The mere usage of the ordinal numbers “first,” “second,” “third,” and so on does not indicate any physical order or location, any ordering in time, or any ranking in importance, quality, or otherwise. In addition, the mere usage of ordinal numbers does not define a numerical limit to the features identified with the ordinal numbers.

When introducing elements, the articles “a,” “an,” “the,” and “said” are intended to mean that there are one or more of the elements. The terms “comprising,” including,” and “having” are intended to be inclusive and mean that there may be additional elements other than the listed elements.

When a single device, component, module, or structure is described, multiple devices, components, modules, or structures (whether or not they cooperate) may instead be used in place of the single device, component, module, or structure. Functionality that is described as being possessed by a single device may instead be possessed by multiple devices, whether or not they cooperate. Similarly, where multiple devices, components, modules, or structures are described herein, whether or not they cooperate, a single device, component, module, or structure may instead be used in place of the multiple devices, components, modules, or structures. Functionality that is described as being possessed by multiple devices may instead be possessed by a single device. In general, a computer system or device can be local or distributed, and a computer system can include any combination of special-purpose hardware and/or hardware with software implementing the functionality described herein.

The respective techniques and tools described herein may be utilized independently and separately from other techniques and tools described herein.

Device, components, modules, or structures that are in communication with each other need not be in continuous communication with each other, unless expressly specified otherwise. On the contrary, such devices, components, modules, or structures need only transmit to each other as necessary or desirable, and they may actually refrain from exchanging data most of the time. For example, a device in communication with another device via the Internet might not transmit data to the other device for weeks at a time. In addition, devices, components, modules, or structures that are in communication with each other may communicate directly or indirectly through one or more intermediaries.

As used herein, the term “send” denotes any way of conveying information from one device, component, module, or structure to another device, component, module, or structure. The term “receive” denotes any way of getting information at one device, component, module, or structure from another device, component, module, or structure. The devices, components, modules, or structures can be part of the same computer system or different computer systems. Information can be passed by value (e.g., as a parameter of a message or function call) or passed by reference (e.g., in a buffer). Depending on context, information can be communicated directly or be conveyed through one or more intermediate devices, components, modules, or structures. As used herein, the term “connected” denotes an operable communication link between devices, components, modules, or structures, which can be part of the same computer system or different computer systems. The operable communication link can be a wired or wireless network connection, which can be direct or pass through one or more intermediaries (e.g., of a network).

As used herein, the term “set,” when used as a noun to indicate a group of elements, indicates a non-empty group, unless context clearly indicates otherwise. That is, the “set” has one or more elements, unless context clearly indicates otherwise.

As used herein, the term “based on” or “based at least in part on” indicates a dependence. A value or output X that is “based on” (or “based at least in part on”) a value or input Y depends on Y but can also depend on additional information or factors. Y can be directly or indirectly used when determining, assigning, generating, calculating, or creating X “based on” (or “based at least in part on”) Y. Thus, for example, the language determining or assigning X “based on” Y can indicate determining or assigning X using Y.

A description of an example with several features does not imply that all or even any of such features are required. On the contrary, a variety of optional features are described to illustrate the wide variety of possible examples of the innovations described herein. Unless otherwise specified explicitly, no feature is essential or required.

Further, although process steps and stages may be described in a sequential order, such processes may be configured to work in different orders. Description of a specific sequence or order does not necessarily indicate a requirement that the steps or stages be performed in that order. Steps or stages may be performed in any order practical. Further, some steps or stages may be performed simultaneously despite being described or implied as occurring non-simultaneously. Description of a process as including multiple steps or stages does not imply that all, or even any, of the steps or stages are essential or required. Various other examples may omit some or all of the described steps or stages. Unless otherwise specified explicitly, no step or stage is essential or required. Similarly, although a product may be described as including multiple aspects, qualities, or characteristics, that does not mean that all of them are essential or required. Various other examples may omit some or all of the aspects, qualities, or characteristics.

An enumerated list of items does not imply that any or all of the items are mutually exclusive, unless expressly specified otherwise. Likewise, an enumerated list of items does not imply that any or all of the items are comprehensive of any category, unless expressly specified otherwise.

For the sake of presentation, the detailed description uses terms like “determine” and “select” to describe computer operations in a computer system. These terms denote operations performed by one or more processors or other components in the computer system, and these terms should not be confused with acts performed by a human being. The actual computer operations corresponding to these terms vary depending on implementation.

In the examples described herein, identical reference numbers in different figures indicate an identical component, module, or operation. More generally, various alternatives to the examples described herein are possible. For example, some of the methods described herein can be altered by changing the ordering of the method acts described, by splitting, repeating, or omitting certain method acts, etc. The various aspects of the disclosed technology can be used in combination or separately. Some of the innovations described herein address one or more of the problems noted in the background. Typically, a given technique or tool does not solve all such problems. It is to be understood that other examples may be utilized and that structural, logical, software, hardware, and electrical changes may be made without departing from the scope of the disclosure.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. One or more computer-readable media having stored thereon computer-executable instructions for causing a processor system, when programmed thereby, to perform operations comprising:
receiving, at a forecasting model, historical features that quantify performance of a machine learning (“ML”) model for previous query batches, the historical features including a time series of historical values of a given error component, the time series of historical values of the given error component including values of the given error component for the previous query batches, respectively;
with the forecasting model, predicting a value of the given error component for a current query batch using the time series of historical values of the given error component;
determining, based at least in part on the predicted value of the given error component for the current query batch, a performance estimate of the ML model for the current query batch; and
determining, based at least in part on the performance estimate of the ML model for the current query batch, whether the ML model exhibits model drift.

2. The one or more computer-readable media of claim 1, wherein the given error component is:
a first error component that quantifies concept drift of the ML model between a training data set and a given query batch, wherein the given query batch is one of the previous query batches or the current query batch;
a second error component that quantifies covariate shift due to difficult-to-classify samples in the training data set becoming more prevalent in the given query batch; or
a third error component that quantifies covariate shift due to infrequent samples in the training data set becoming more prevalent in the given query batch.

3. The one or more computer-readable media of claim 1, wherein the predicting the value of the given error component for the current query batch includes:
determining an auto-regressive value for the current query batch based on auto-regression of the time series of historical values of the given error component, wherein the predicted value of the given error component for the current query batch incorporates the auto-regressive value for the current query batch.

4. The one or more computer-readable media of claim 3, wherein the auto-regression of the time series of historical values of the given error component uses linear auto-regression, a neural network with a single hidden layer, or a neural network with multiple hidden layers.

5. The one or more computer-readable media of claim 3, wherein the given error component is a first error component, and wherein the predicting the value of the given error component for the current query batch further includes:
determining a lagged regressor value for the current query batch based on auto-regression of a time series of historical values of a second error component, the second error component being different than the first error component, wherein the predicted value of the given error component for the current query batch also incorporates the lagged regressor value for the current query batch.

6. The one or more computer-readable media of claim 3, wherein the predicting the value of the given error component for the current query batch further includes one or more of:
determining a trend value for the current query batch, wherein the trend value for the current query batch is determined by projecting along a trendline that has been fit to a training data set of the ML model, and wherein the predicted value of the given error component for the current query batch also incorporates the trend value for the current query batch;
determining a seasonality value for the current query batch, wherein the seasonality value for the current query batch quantifies seasonality effects according to a seasonality model that has been fit to the training data set of the ML model, and wherein the predicted value of the given error component for the current query batch also incorporates the seasonality value for the current query batch; and
determining an events value for the current query batch, wherein the events value quantifies effects of events for current query batch, and wherein the predicted value of the given error component for the current query batch also incorporates the events value for the current query batch.

7. The one or more computer-readable media of claim 1, wherein the given error component is a first error component among multiple error components, wherein the forecasting model includes multiple sub-models configured for the multiple error components, respectively, and wherein the operations further include:
with the forecasting model, predicting a value of a second error component, among the multiple error components, for the current query batch using a time series of historical values of the second error component, wherein the performance estimate of the ML model for the current query batch is also based at least in part on the predicted value of the second error component for the current query batch; and
with the forecasting model, predicting a value of a third error component, among the multiple error components, for the current query batch using a time series of historical values of the third error component, wherein the performance estimate of the ML model for the current query batch is also based at least in part on the predicted value of the third error component for the current query batch.

8. The one or more computer-readable media of claim 1, wherein the determining the performance estimate includes adjusting, based at least in part on the predicted value of the given error component for the current query batch, a measure of performance of the ML model for a training data set.

9. The one or more computer-readable media of claim 1, wherein the determining whether the ML model exhibits model drift includes comparing the performance estimate to a performance threshold.

10. The one or more computer-readable media of claim 1, wherein the operations further comprise:
selectively retraining the ML model, including selecting between complete retraining of the ML model, partial retraining of the ML model, and skipping retraining of the ML model.

11. The one or more computer-readable media of claim 1, wherein the operations further comprise updating the historical features that quantify performance of the ML model:
determining a value of the given error component for the current query batch using labeled samples, the labeled samples including labeled samples of the current query batch; and
updating the time series of historical values of the given error component to include the value of the given error component for the current query batch.

12. The one or more computer-readable media of claim 11, wherein the determining the value of the given error component for the current query batch includes:
determining a first loss metric that quantifies average loss for a training data set;
using a classifier model to identify a subset of samples of the training data set that are in a region of shared support with the current query batch;
determining a second loss metric that quantifies average loss for the subset of samples of the training data set in the region of shared support; and
determining a difference between the second loss metric and the first loss metric.

13. The one or more computer-readable media of claim 11, wherein the determining the value of the given error component for the current query batch includes:
using a classifier model to identify a subset of samples of the current query batch that are in a region of shared support with a training data set;
determining a first loss metric that quantifies average loss for the subset of samples of the current query batch in the region of shared support; and
determining a second loss metric that quantifies average loss for the current query batch; and
determining a difference between the second loss metric and the first loss metric.

14. A computer system comprising a processor set and memory, wherein the computer system is configured to perform operations comprising:
using a forecasting model to forecast model drift, for a current query batch, of a machine learning (“ML”) model based on historical features that quantify performance of the ML model for previous query batches, the historical features including a time series of historical values of a given error component, the time series of historical values of the given error component including values of the given error component for the previous query batches, respectively;
selectively retraining the ML model based on results of the using the forecasting model to forecast model drift, including selecting between complete retraining of the ML model, partial retraining of the ML model, and skipping retraining of the ML model;
if the ML model has been completely or partially retrained, resetting the historical features that quantify performance of the ML model; and
otherwise, the retraining of the ML model having been skipped, updating the historical features that quantify performance of the ML model.

15. The computer system of claim 14, wherein the using the forecasting model to forecast model drift of the ML model includes:
receiving, at the forecasting model, the historical features that quantify performance of the machine learning model for the previous query batches;
with the forecasting model, predicting a value of the given error component for the current query batch using the time series of historical values of the given error component;
determining, based at least in part on the predicted value of the given error component for the current query batch, a performance estimate of the ML model for the current query batch; and
determining, based at least in part on the performance estimate of the ML model for the current query batch, whether the ML model exhibits model drift.

16. The computer system of claim 14, wherein the selectively retraining the ML model includes:
determining that the ML model exhibits model drift due to concept drift of the ML model between a training data set and the current query batch; and
in response to the determining that the ML model exhibits model drift due to concept drift, performing complete retraining of the ML model using recent labeled samples, the recent labeled samples including labeled samples of the current query batch.

17. The computer system of claim 14, wherein the selectively retraining the ML model includes:
determining that the ML model exhibits covariate shift due to difficult-to-classify samples in the training data set becoming more prevalent in the current query batch; and
in response to the determining that the ML model exhibits covariate shift due to difficult-to-classify samples in the training data set becoming more prevalent in the current query batch, performing partial retraining of the ML model using mis-classified samples from the training data set.

18. The computer system of claim 14, wherein the selectively retraining the ML model includes one of:
determining that the ML model exhibits covariate shift due to infrequent samples in the training data set becoming more prevalent in the current query batch; and
in response to the determining that the ML model exhibits covariate shift due to infrequent samples in the training data set becoming more prevalent in the current query batch, performing partial retraining of the ML model using recent labeled samples that were not in the training data set.

19. The computer system of claim 14, wherein the updating the historical features that quantify performance of the ML model includes, when labeled samples of the current query batch are available:
determining a value of the given error component for the current query batch using the labeled samples of the current query batch; and
updating the time series of historical values of the given error component to include the value of the given error component for the current query batch.

20. In a computer system, a method comprising:
training a forecasting model to forecast model drift of a machine learning (“ML”) model, wherein the training includes, in each of multiple training iterations:
receiving, at the forecasting model, historical features that quantify performance of the ML model for previous training batches, the historical features including a time series of historical values of a given error component, the time series of historical values of the given error component including values of the given error component for the previous training batches, respectively;
with the forecasting model, predicting a value of the given error component for a current training batch using the time series of historical values of the given error component;
determining, based at least in part on the predicted value of the given error component for the current training batch, a performance estimate of the ML model for the current training batch;
determining feedback based at least in part on differences between the performance estimate of the ML model for the current training batch and a performance metric of the ML model for the current training batch; and
adjusting the forecasting model based at least in part on the feedback;
storing the forecasting model.
